(19) United States
(12) Patent Application Publication
(10) Pub. No.: US 2026/0126596 A1
(43) Pub. Date: May 7, 2026

(54) LC FIBER OPTIC CONNECTOR

(71) Applicant: Zhejiang Oryarwa Communication Equipment Co., Ltd, Yueqing City (CN)

(72) Inventors: Jianyong TANG, Yueqing City (CN); Xiaokuang WANG, Yueqing City (CN); Rongqian LIN, Yueqing City (CN); Cong LUO, Yueqing City (CN)

(21) Appl. No.: 19/034,992

(22) Filed: Jan. 23, 2025

(30) Foreign Application Priority Data
Nov. 7, 2024 (CN) 202422707889.9

(51) Int. Cl. G02B 6/38; G02B 6/40

(52) U.S. Cl. CPC G02B 6/387; G02B 6/3831; G02B 6/406

(57) ABSTRACT

An LC fiber optic connector is disclosed in the present application, and the LC fiber optic connector includes a duplex socket, a ferrule assembly and a tail boot assembly, the ferrule assembly includes an outer frame bushing, an inner frame bushing, a ferrule and a spring disposed within the inner frame bushing; the tail boot assembly includes a front boot and a tail boot located at a rear end of the front boot, the rotating bushing is integrally formed with an elastic buckle, a rear end of the elastic buckle extends with an unlocking pressing portion, a resisting portion is located inside the unlocking through hole of the unlocking press portion, and the resisting portion includes an inclined surface, a inclined rod of the front boot extends into the unlocking through hole and cooperates with the inclined surface.

### FIELD

The present application relates to the field of optical fiber communication technology, in particular to an LC fiber optic connector.

### BACKGROUND

In the use of traditional lucent connector (LC) duplex connectors, if the two polarities are reversed, an operator needs to cut off the connector and replace it with a new connector, resulting in waste. In order to solve the above problem, Applicant has applied for a Chinese utility model patent with Publication No. ‘CN 207965232 U’ and the title of ‘A changeable polarity LC duplex connector’, a rotating sleeve can be set up so that the duplex bayonet can be installed in the forward and the reverse directions, thus achieving polarity interchangeability. However, after the above described LC duplex connector is connected to the adapter or module, the resistance of pushing and pulling the tail boot is high, making it difficult for the front boot to detach from the adapter or the module. Furthermore, the above described LC duplex connector requires a lot of components, which makes it difficult to assemble.

Therefore, improvement is desired.

### SUMMARY OF THE DISCLOSURE

An LC fiber optic connector is provided so that the LC fiber optic connector is easy to plug and unplug.

The LC fiber optic connector disclosed by the present application includes a duplex socket, a ferrule assembly clamped on both sides of the duplex socket and a tail boot assembly sleeved outside the duplex socket, wherein: the ferrule assembly includes an outer frame bushing, an inner frame bushing disposed at a front end of the outer frame bushing, a rotating bushing rotatably disposed at a front end of the inner frame bushing, and a ferrule and a spring disposed within the inner frame bushing; and the tail boot assembly includes a front boot and a tail boot located at a rear end of the front boot, the rotating bushing is integrally formed with an elastic buckle, a rear end of the elastic buckle extends with an unlocking pressing portion, the unlocking press portion defines an unlocking through hole, the unlocking press portion is also provided with a resisting portion, the resisting portion is located inside the unlocking through hole, the resisting portion is fixedly connected to an inner side of an end portion of the unlocking press portion, and the resisting portion comprises an inclined surface, a front end of the front boot is provided with an inclined rod, and the inclined rod extends into the unlocking through hole and cooperates with the inclined surface.

Optionally, the tail boot includes a boot and a handle integrally formed at an end portion of the boot.

Optionally, an inclination angle of the inclined surface is in a range between 40° and 50°, and an inclination angle of the inclined rod is in a range between 40° and 50°.

Optionally, the front boot is connected to a locking member by a rotating shaft, the locking member includes a base body, a locking pin, and a locking knob integrally formed on a circumferential surface of the base body, and the duplex socket defines a locking groove, and the locking groove matches the locking pin.

Optionally, two positioning bumps are respectively provided on two sides of the locking knob, the front boot defines an accommodating groove, the accommodating groove is configured to accommodate the locking knob, the accommodating groove defines two positioning groove, and two positioning grooves are respectively matched with two positioning bumps.

Optionally, two sides of the duplex socket are respectively provided with U-shaped openings, and the duplex socket is snapped to the outer frame bushing through the U-shaped openings, two guide rails are respectively disposed on two sides of the U-shaped opening, two sliding grooves are respectively defined on two sides of the front boot, and the two guide rails respectively cooperate with the two sliding grooves.

Optionally, the inclination angle of the inclined surface is 45°, and the inclination angle of the inclined rod is 45°.

Optionally, the front boot and the tail boot are integrated structures.

The advantages of the LC fiber optic connector of the present application are as follows: the inclined rod at the front end of the front boot is matched with the inclined surface of the unlocking pressing portion, which is not only easy to push and pull the tail boot, but also easy to disengagement the elastic buckle.

### BRIEF DESCRIPTION OF THE DRAWINGS

Implementations of the present application will now be described, by way of embodiments, with reference to the attached figures.

FIG. 1 is a schematic diagram of an embodiment of a lucent connector (LC) fiber optic connector of the present application.

FIG. 2 is an exploded view of the LC fiber optic connector of FIG. 1.

FIG. 3 is a cross-sectional view of the LC fiber optic connector, taken along line A-A of FIG. 1.

FIG. 4 is a cross-sectional view of the LC fiber optic connector, taken along line B-B of FIG. 1.

FIG. 5 is a schematic diagram of a tail boot assembly of the present application.

FIG. 6 is a schematic diagram of a rotating sleeve of the present application.

FIG. 7 is a schematic diagram of a locking member of the present application.

FIG. 8 is a schematic diagram of a duplex socket of the present application.

### DETAILED DESCRIPTION

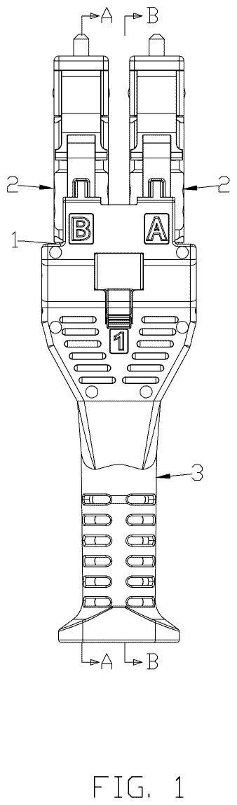

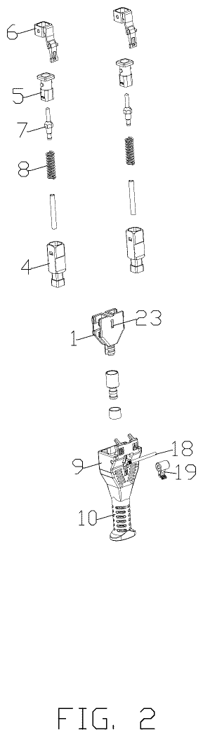

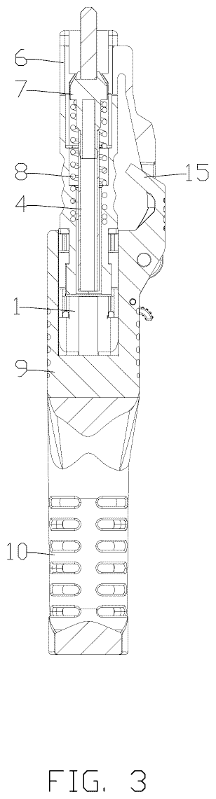

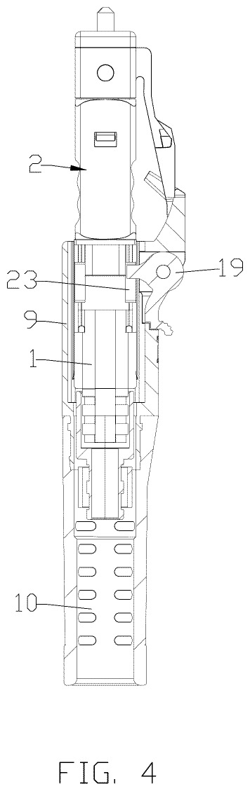

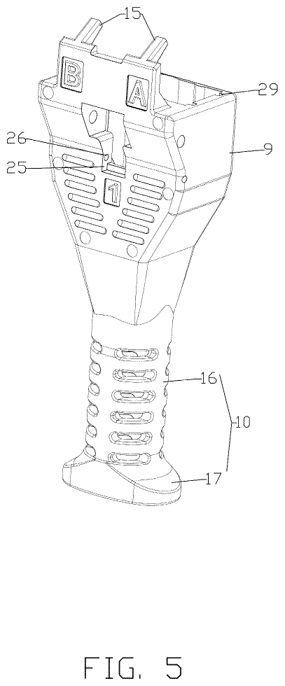

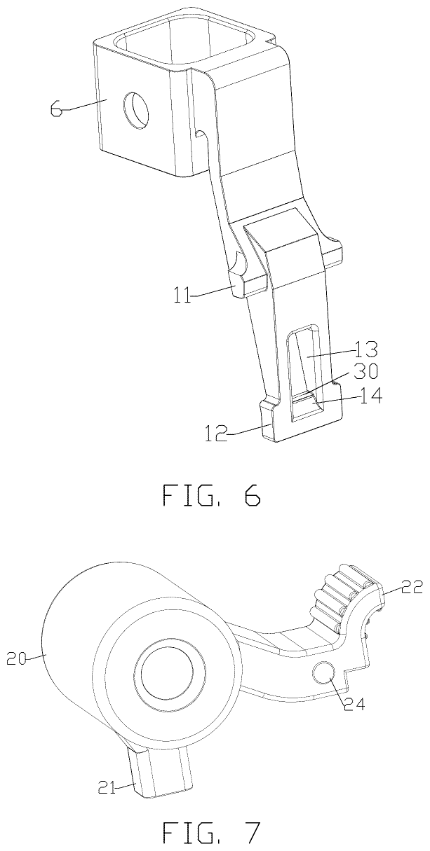

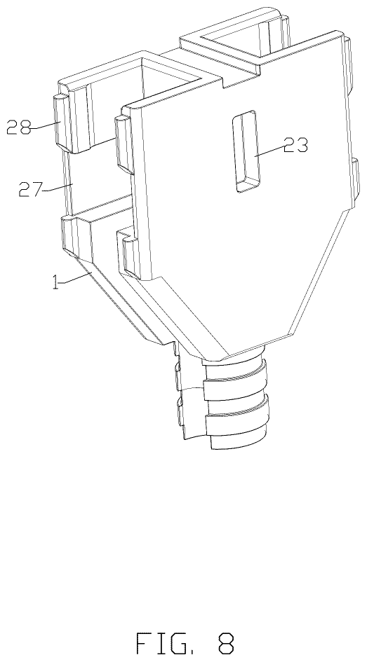

Referring to FIGS. 1 to 8, a lucent connector (LC) fiber optic connector provided by the present application includes a duplex socket 1, a ferrule assembly 2 clamped on both sides of the duplex socket 1 and a tail boot assembly 3 sleeved outside the duplex socket 1. The ferrule assembly 2 includes an outer frame bushing 4, an inner frame bushing 5 disposed at the front end of the outer frame bushing 4, a rotating bushing 6 rotatably disposed at the front end of the inner frame bushing 5, and a ferrule 7 and a spring 8 disposed within the inner frame bushing 5. The tail boot assembly 3 includes a front boot 9 and a tail boot 10 located at the rear end of the front boot 9, and the front boot 9 is slidably sleeved on the duplex socket 1. The rotating bushing 6 is integrally formed with an elastic buckle 11, the elastic buckle 11 has an unlocking press portion 12 extending from the rear end of the elastic buckle 11, the unlocking press portion 12 defines an unlocking through hole 13, the unlocking press portion 12 is also provided with a resisting portion 30, the resisting portion 30 is located inside the unlocking through hole 13, the resisting portion 30 is fixedly connected to the inner side of the end portion of the unlocking press portion 12, and the resisting portion 30 includes an inclined surface 14. The front end of the front boot 9 is provided with an inclined rod 15 that extends into the unlocking through hole 13 and cooperates with the inclined surface 14. When the front boot 9 is pulled backwards, the inclined rod 15 presses against the inclined surface 14, thereby pressing down the elastic buckle 11 to achieve the disengagement between the LC fiber optic connector and the adapter or the module.

Optionally, the tail boot 10 includes a boot 16 and a handle 17 integrally formed at the end portion of the boot 16. It can be understood that the optical fiber can pass through the boot 16 and be connected to the ferrule assembly 2, so that the tail boot 10 can provide protection for the optical fiber and unlock the tail boot, thereby simplifying the components and installation.

Optionally, the inclination angles of the inclined surface 14 and the inclined rod 15 are both in a range between 40° and 50°, and the ideal inclination angle for the inclined surface 14 and the inclined rod 15 is 45°, which can achieve the best disengagement effect.

Optionally, the front boot 9 is connected to a locking member 19 by a rotating shaft 18, the locking member 19 includes a cylindrical base body 20 and a locking pin 21 and a locking knob 22 integrally formed on the circumferential surface of the base body 20. The duplex socket 1 is provided with a locking groove 23 that matches the locking pin 21. When the locking member 19 is rotated, the locking pin 21 is pressed against the end portion of the locking groove 23, and the front boot 9 can be locked and prevented from being unbuckled.

Optionally, two positioning bumps 24 are respectively provided on two sides of the locking knob 22, the front boot 9 defines an accommodating groove 25, the accommodating groove 25 is used to accommodate the locking knob 22, the accommodating groove 25 defines two positioning groove 26, and two positioning groove 26 are respectively matched with two positioning bumps 24 for positioning.

Optionally, two inner sides of the duplex socket 1 are respectively provided with U-shaped openings 27, and the duplex socket 1 is snapped to the outer frame bushing 4 through the U-shaped openings 27 on the two inner sides, two guide rails 28 are respectively disposed on two sides of the U-shaped opening 27, two sliding grooves 29 are respectively defined on two sides of the front boot 9, and the two guide rails 28 respectively cooperate with the two sliding grooves 29, which can make the sliding of the front boot 9 more stable and smooth.

Optionally, the front boot 9 and the tail boot 10 are integrated structures. Specifically, the front cover 9 can be re injected to form an integrated tail boot at its tail end, reducing components and assembly while improving strength.

Even though numerous characteristics and advantages of the present technology have been set forth in the foregoing description, together with details of the structure and function of the present application, the application is illustrative only, and changes may be made in the detail, especially in matters of shape, size, and arrangement of the parts within the principles of the present application, up to and including the full extent established by the broad general meaning of the terms used in the claims. It will, therefore, be appreciated that the exemplary embodiments described above may be modified within the scope of the claims.

What is claimed is:

1. A lucent connector (LC) fiber optic connector comprising a duplex socket; a ferrule assembly clamped on each side of the duplex socket; and a tail boot assembly sleeved outside the duplex socket, wherein:
the ferrule assembly comprises an outer frame bushing, an inner frame bushing disposed at a front end of the outer frame bushing, a rotating bushing rotatably disposed at a front end of the inner frame bushing, and a ferrule and a spring disposed within the inner frame bushing; and
the tail boot assembly comprises a front boot and a tail boot located at a rear end of the front boot, the rotating bushing comprises an elastic buckle integrally formed with the rotating bushing, an unlocking pressing portion is extended from a rear end of the elastic buckle, the unlocking press portion defines an unlocking through hole, the unlocking press portion further comprising a resisting portion, the resisting portion is located inside the unlocking through hole, the resisting portion is fixedly connected to an inner side of an end portion of the unlocking press portion, and the resisting portion comprises an inclined surface, the tail boot further comprises an inclined rod at a front end of the front boot, and the inclined rod extends into the unlocking through hole and cooperates with the inclined surface.

2. The LC fiber optic connector according to claim 1, wherein the tail boot further comprises a boot and a handle integrally formed at an end portion of the boot.

3. The LC fiber optic connector according to claim 1, wherein an inclination angle of the inclined surface is in a range between 40° and 50°, and an inclination angle of the inclined rod is in a range between 40° and 50°.

4. The LC fiber optic connector according to claim 1, further comprising a locking member connected to the front boot by a rotating shaft, wherein the locking member comprises a base body, a locking pin, and a locking knob integrally formed on a circumferential surface of the base body, and the duplex socket defines a locking groove, and the locking groove matches the locking pin.

5. The LC fiber optic connector according to claim 4, wherein the locking member further comprises two positioning bumps respectively provided on two sides of the locking knob, the front boot defines an accommodating groove, the accommodating groove is configured to accommodate the locking knob, the accommodating groove defines two positioning groove, and two positioning grooves are respectively matched with two positioning bumps.

6. The LC fiber optic connector according to claim 1, wherein two sides of the duplex socket are respectively provided with U-shaped openings, and the duplex socket is snapped to the outer frame bushing through the U-shaped openings, two guide rails are respectively disposed on two sides of the U-shaped opening, two sliding grooves are respectively defined on two sides of the front boot, and the two guide rails respectively cooperate with the two sliding grooves.

7. The LC fiber optic connector according to claim 3, wherein the inclination angle of the inclined surface is 45°, and the inclination angle of the inclined rod is 45°.

8. The LC fiber optic connector according to claim 1, wherein the front boot and the tail boot are ab integrated structure.

9. A lucent connector (LC) fiber optic connector comprising a duplex socket; a ferrule assembly clamped on each side of the duplex socket; and a tail boot assembly sleeved outside the duplex socket, wherein:
the ferrule assembly comprises an outer frame bushing, an inner frame bushing disposed at a front end of the outer frame bushing, a rotating bushing rotatably disposed at a front end of the inner frame bushing, and a ferrule and a spring disposed within the inner frame bushing; and
the tail boot assembly comprises a front boot and a tail boot located at a rear end of the front boot, the rotating bushing comprises an elastic buckle integrally formed with the rotating bushing, an unlocking pressing portion is extended from a rear end of the elastic buckle, the unlocking press portion defines an unlocking through hole, the unlocking press portion further comprising a resisting portion, the resisting portion is located inside the unlocking through hole, the resisting portion is fixedly connected to an inner side of an end portion of the unlocking press portion, and the resisting portion comprises an inclined surface, the tail boot further comprises an inclined rod at a front end of the front boot, and the inclined rod extends into the unlocking through hole and cooperates with the inclined surface;
wherein the tail boot comprises a boot and a handle integrally formed at an end portion of the boot; and
wherein the front boot is connected to a locking member by a rotating shaft, the locking member comprises a base body, a locking pin, and a locking knob integrally formed on a circumferential surface of the base body, and the duplex socket defines a locking groove, and the locking groove matches the locking pin.

10. The LC fiber optic connector according to claim 9, wherein an inclination angle of the inclined surface is in a range between 40° and 50°, and an inclination angle of the inclined rod is in a range between 40° and 50°.

11. The LC fiber optic connector according to claim 9, wherein the locking member further comprises two positioning bumps respectively provided on two sides of the locking knob, the front boot defines an accommodating groove, the accommodating groove is configured to accommodate the locking knob, the accommodating groove defines two positioning groove, and two positioning grooves are respectively matched with two positioning bumps.

12. The LC fiber optic connector according to claim 9, wherein two sides of the duplex socket are respectively provided with U-shaped openings, and the duplex socket is snapped to the outer frame bushing through the U-shaped openings, two guide rails are respectively disposed on two sides of the U-shaped opening, two sliding grooves are respectively defined on two sides of the front boot, and the two guide rails respectively cooperate with the two sliding grooves.

13. The LC fiber optic connector according to claim 10, wherein the inclination angle of the inclined surface is 45°, and the inclination angle of the inclined rod is 45°.

14. The LC fiber optic connector according to claim 9, wherein the front boot and the tail boot are integrated structure.
